(19) United States
(12) Patent Application Publication
(10) Pub. No.: US 2012/0231203 A1
(43) Pub. Date: Sep. 13, 2012

(54) NON-WOVEN FIBER SEATING PADDING

(75) Inventors: Ashford A. Galbreath, Troy, MI (US); Asad S. Ali, Troy, MI (US); Terry O'Bannon, Royal Oak, MI (US); Gary Rock, Canton, MI (US)

(73) Assignee: LEAR CORPORATION, Southfield, MI (US)

(21) Appl. No.: 13/512,535

(22) PCT Filed: Feb. 26, 2010
(86) PCT No.: PCT/US10/25571

§ 371 Date: May 29, 2012

(51) Int. Cl. B60R 21/04; B32B 3/02; A47C 7/02

(52) U.S. Cl. 428/68; 297/452.48; 296/187.03

(57) ABSTRACT

A deformable structure for automotive interior components includes a substrate and a cushion element. The cushion element is disposed over the substrate. The cushion element includes a fiber pad and a fibrous cushion section, each of which has cellulosic fibers. The deformable structure also includes a cover disposed over the cushion element. The cushion element is substantially free of any resinous foams. A vehicle seat and trim laminate incorporating the deformable structure is also provided.

### BACKGROUND OF THE INVENTION

1. Field of the Invention

The present invention relates to a deformable structure that is useful in automotive interior applications.

2. Background Art

Automobile manufacturers and suppliers constantly strive to improve the aesthetic appeal of vehicle interior components. Such considerations have influenced the design of vehicle interior trim, seat, and console components to name a few. Environmental concerns place additional manufacturing pressures on vehicle design with renewable component being of paramount importance.

Many automobile interior components include resinous foams such as polyurethane. In a typical interior application, an interior component will include a foam over a suitable frame or backing. Such resinous foams are found in vehicle trim laminates, vehicle seats, head restraints, armrests, dashboards, and the like. These foams function to provide cushioning or a soft feel to the interior component which is desirable to consumers. Although these foams work reasonably well, they are not renewable resource-derived, easily recycled, are derived from petroleum, or biodegradable.

Accordingly, there is a need for improved automobile components that provide a cushioning effect are renewable resource-derived, include recycled content, while being at least partially recyclable.

### SUMMARY OF THE INVENTION

The present invention solves one or more problems of the prior art by providing in at least one embodiment a cushion element for automotive interior components. The cushion element includes a molded seat bottom comprising cellulosic fibers. Advantageously, substantially all of the molded seat bottom is made from recycled content, recyclable and derived from a renewable source.

In another embodiment of the present invention, a deformable structure for automotive interior components is provided. The deformable structure of the present embodiment incorporates the cushion element set forth above. The deformable structure comprises a substrate and the cushion element. The cushion element is positioned over the substrate. The cushion element includes a fiber section which has cellulosic fibers. The deformable structure also includes a cover disposed over the cushion element. Advantageously, at least a portion of the fiber section is recyclable and derived from a renewable source.

### BRIEF DESCRIPTION OF THE DRAWINGS

FIG. 1 is an exposed perspective view of a vehicle seat having a renewable fiber pad disposed over a fibrous cushion component;

FIG. 2A is a cross section of a variation of a deformable structure in which a fiber pad covers a fibrous cushion section;

FIG. 2B is a cross section of a variation of a deformable structure in which a fiber pad covers edge portions of a fibrous cushion section;

FIG. 2C is a cross section of a variation of a deformable structure in which a fiber pad covers a portion of a fibrous cushion section;

FIG. 3 is an exposed perspective view of a deformable structure incorporating renewable fibers; and

FIG. 4 is a flowchart showing the formation of fibrous cushion sections by compression molding.

### DETAILED DESCRIPTION OF THE PREFERRED EMBODIMENT(S)

Reference will now be made in detail to presently preferred compositions, embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

Except in the examples, or where otherwise expressly indicated, all numerical quantities in this description indicating amounts of material or conditions of reaction and/or use are to be understood as modified by the word “about” in describing the broadest scope of the invention.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

Throughout this application, where publications are referenced, the disclosures of these publications in their entireties are hereby incorporated by reference into this application to more fully describe the state of the art to which this invention pertains.

The term “caliper thickness” as used herein means the perpendicular separation between the two surfaces of a sheet.

In an embodiment of the present invention, a deformable structure for use in a number of different automotive interior components is provided. The deformable structure comprises a substrate and a cushion element. The cushion element is disposed over the substrate. The deformable structure is advantageously incorporated in head restraints, vehicle seats, armrests, dashboard, vehicle trim panels, and other trim laminates. As set forth in the background section, prior art versions of such structures generally includes a resinous foam (e.g., polyurethane foam) to provide cushioning properties. The cushion element of the present embodiment substantially entirely replaces these foams as set forth below in more detail. In one refinement, the cushion element of the invention includes less than 50 weight percent of a resinous foam (e.g., polyurethane foam). In another refinement, the cushion element of the invention includes less than 5 weight percent of a resinous foam (e.g., polyurethane foam). In still another refinement, the cushion element of the invention includes greater than 90 weight percent of a fibrous component (fibers and binder). In still another refinement, the cushion element of the invention includes greater than 95 weight percent of a fibrous component (fibers and binder).

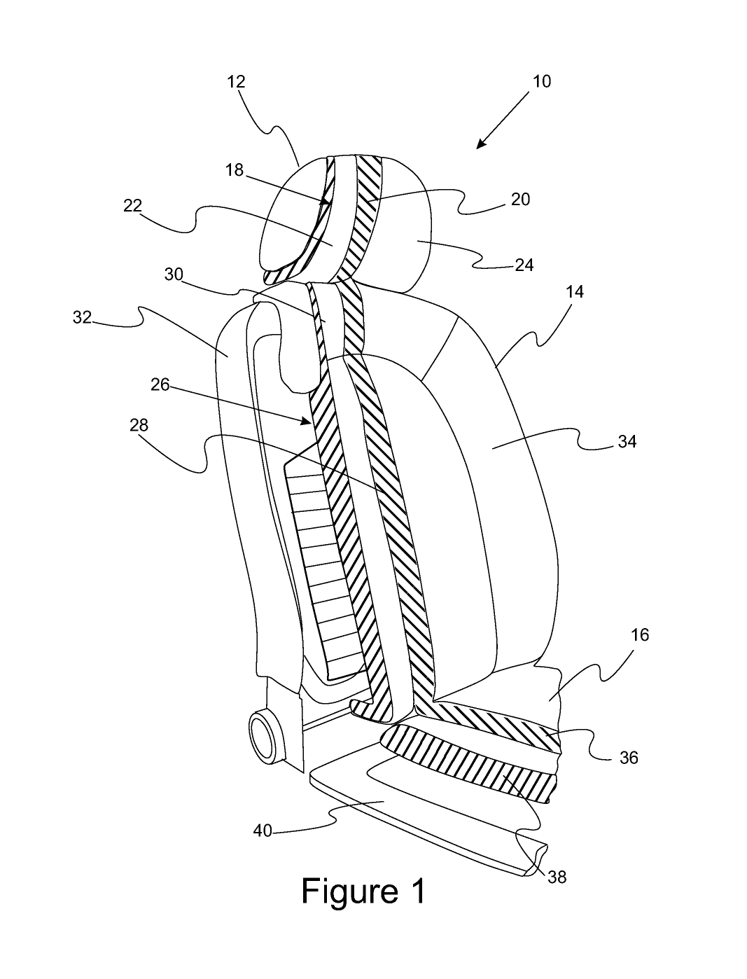

With reference to FIG. 1, a perspective view of a vehicle seat incorporating cellulose-containing fiber layers and fibrous cushion sections is provided. Vehicle seat 10 includes head restraint 12, vehicle seat back 14 and vehicle seat bottom 16. Head restraint 12 includes cushion element 18. Cushion element 18 includes fibrous pad 20 positioned over fibrous cushion section 22. Cover 24 overlays fibrous layer 20. Vehicle seat back 14 includes seat back cushion element 26 which includes a fibrous pad 28 positioned over fibrous cushion section 30. Fibrous cushion 30 overlays seat back frame 32 while cover 34 overlays fibrous pad 28. Fibrous pad 20 includes cellulose fibers as set forth above. Similarly, vehicle seat bottom 16 includes fibrous pad 36 positioned over fibrous cushion section 38. Fibrous cushion section 38 is positioned over seat bottom frame 40.

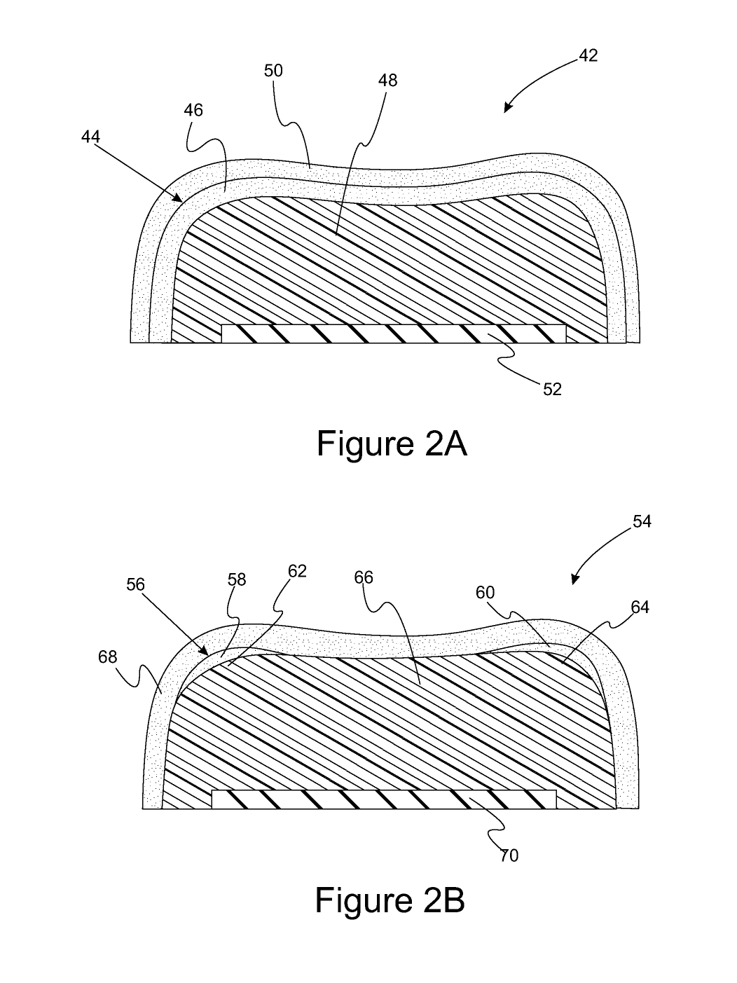

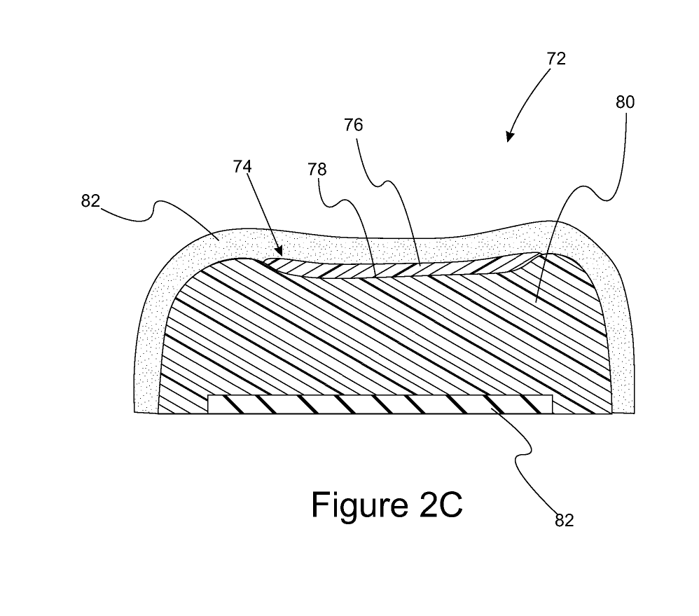

With reference to FIG. 2A, a schematic cross section of a fiber pad positioned over a fibrous cushion section is provided. In this variation, deformable structure 42 includes cushion element 44. In this variation, cushion element 44 is a multi-component structure. Cushion element 44 includes fibrous pad 46 and fibrous cushion section 48. Fibrous pad 46 covers at least a portion of fibrous cushion section 48. Pad 46 includes a mixture of cellulose fibers and synthetic fibers. Similarly, fibrous cushion section 48 includes a mixture of cellulose fibers and synthetic fibers. As set forth above, cover 50 is positioned over cushion element 44. Finally, cushion element 44 is optionally positioned over substrate 52. For example, substrate 52 may be a part of a head restraint or seat frame or a backing for a trim laminate.

With reference to FIG. 2B, a schematic cross section of a variation in which several fiber pads are positioned over sections of a fibrous cushion section is provided. In this variation, deformable structure 54 includes cushion element 56. Cushion element 56 includes fibrous pads 58, 60 which covers portions 62, 64 of fibrous cushion section 66. Fibrous pads 58, 60 cover at least a portion of fibrous cushion section 66. Pads 58, 60 include a mixture of cellulose fibers and synthetic fibers. Similarly, fibrous cushion section 66 includes a mixture of cellulose fibers and synthetic fibers. As set forth above, cover 68 is positioned over cushion element 56. Finally, cushion element 56 is optionally positioned over substrate 70. For example, substrate 70 may be a part of a head restraint or seat frame or a backing for a trim laminate.

With reference to FIG. 2C, a schematic cross section of a variation in which fiber pads are positioned over a portion of a fibrous cushion section is provided. In this variation, deformable structure 72 includes cushion element 74. Cushion element 74 includes fibrous pad 76 which covers portion 78 of fibrous cushion section 80. Pad 76 includes a mixture of cellulose fibers and synthetic fibers. Similarly, fibrous cushion section 80 includes a mixture of cellulose fibers and synthetic fibers. As set forth above, cover 82 is positioned over cushion element 74. Finally, cushion section 80 is optionally positioned over substrate 82. For example, substrate 82 may be a part of a head restraint or seat frame or a backing for a trim laminate.

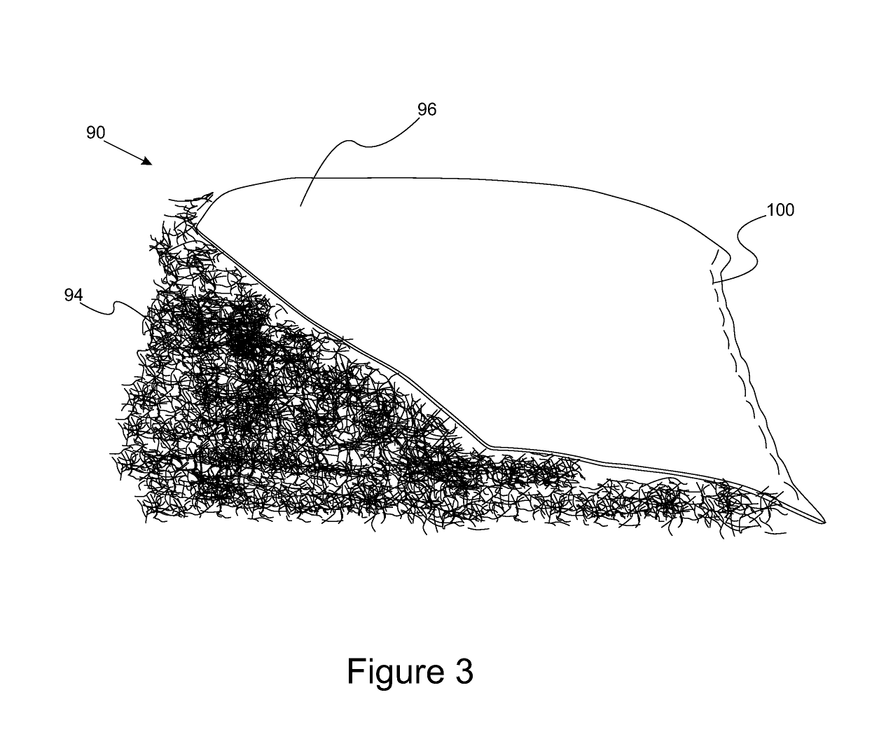

With reference to FIG. 3, an exposed perspective view of an embodiment of a deformable structure for automotive interior applications is provided. Deformable structure 90 includes fibrous cushion 94. Fibrous cushion 94 includes cellulosic fibers. In other variations, fibrous cushion 94 includes additional cushion components such as additional fibrous pad sections. Advantageously, substantially all of fibrous cushion 94 is recyclable and derived from a renewable source. Examples of a renewable source are fast growth pine trees. This source of materials is to be contrasted to petroleum-derived raw materials used in polyurethane trim laminates and foam cushion elements.

Still referring to FIG. 3, cover 96 is disposed over fibrous cushion 94. Cover 96 acts to secure cushion 94 in place while providing an aesthetically pleasing appearance and feel. Cover 96 is formed from any suitable material used in vehicle interior applications. Examples of such materials include, but are not limited to, non-woven fabrics, woven fabrics, leather, plastic sheets, vinyl sheets, and combinations thereof. FIG. 3 depicts an example in which cover 96 is stitched in place via stitching 100.

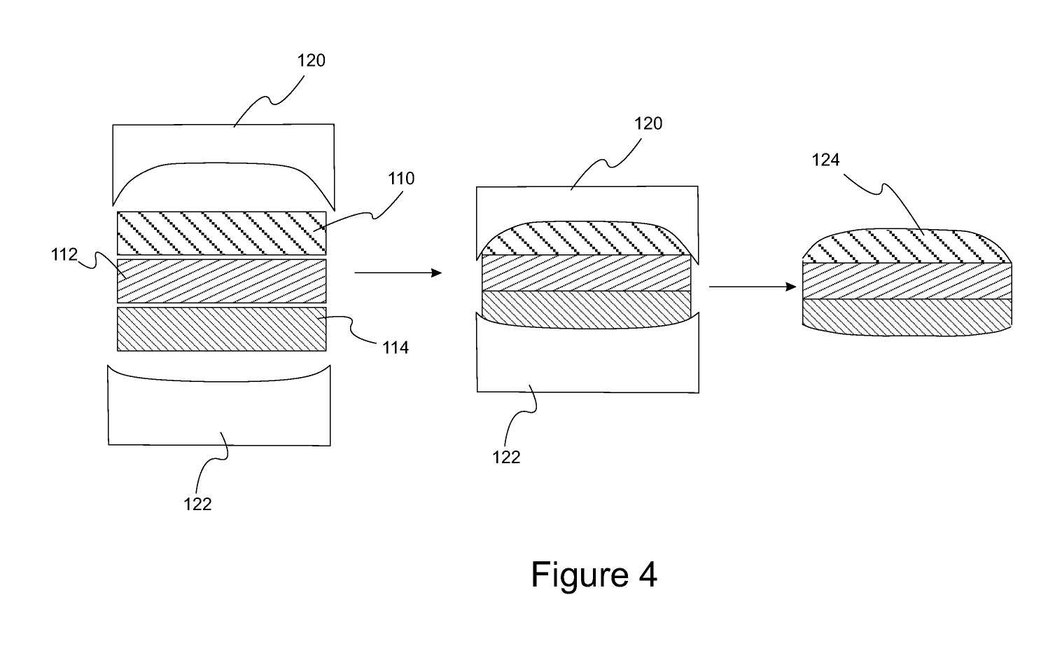

With reference to FIG. 4, a flowchart showing the formation of fibrous cushion sections 22, 30, 38, 48, 66, 80 by compression molding is provided. Fibrous sheets 110, 112, 114 are assembled together by overlaying. Fibrous sheets 110, 112, 114 are characterized by having different properties. Typically, fibrous sheets 110, 112, 114 are preheated to a temperature of about 250° F. to about 300° F. In step a), the assembly of fibrous sheets 110, 112, 114 are subjected to compression molding by placing the assembly between metal mold sections 120, 122. Mold sections 120, 122 are heated to an elevated temperature (e.g., about 150° F.). After about 3-5 minutes, metal mold sections 120, 122 are retracted to reveal molded cushion section 124. Variation pads are then added to produce the cushion construction set forth in FIGS. 1-3.

As set forth above, in some variations one or more of fibrous sheets 110, 112, 114 have different properties. In one variation, one or more of fibrous sheets 110, 112, 114 have different compositions of fibers. In another variation, one or more of fibrous sheets 110, 112, 114 have different hardness. For example, a cushion section 124 with a hardness gradient is constructed when fibrous sheet 114 has a higher hardness than fibrous sheet 112 which, in turn, has a higher hardness than fibrous sheet 110. Typically, fibrous sheets 110, 112, 114 have densities from about 45 to about 65 kg/m³.

As set forth above, embodiments of the present invention include one or more fiber sections (i.e., fibrous pads, fibrous cushions, etc) which include cellulose fibers. For example, fibrous pads 20, 28, 36, 46, 58, 60, 76 and fibrous cushion sections 22, 30, 38, 48, 66, 80 described above all include cellulose fibers. U.S. patent application no. 20080050565 provides examples of useful materials for the fiber section. The entire disclosure of this patent application is hereby incorporated by reference. Examples of useful cellulose fibers include, but are not limited to, cellulose acetate and regenerated cellulose (e.g., viscose rayon).

In a variation of the present embodiment, the cellulose fibers are blended with synthetic fibers. Examples of useful synthetic fibers include, but are not limited to, polyester fibers, nylon fibers, latex fibers, polyethylene fibers, polypropylene fibers, and combinations thereof. In a refinement, the synthetic fibers are present in an amount ranging from about 15 weight percent to about 95 weight percent based on the total weight of the fiber section. In another refinement, the synthetic fibers are present in a combined amount ranging from about 25 weight percent to about 60 weight percent based on the total weight of the fiber section.

In a variation of the present embodiment, fibrous pads 20, 28, 36, 46, 58, 60, 76 and/or fibrous cushion sections 22, 30, 38, 48, 66, 80 set forth above have a caliper thickness of from about 1.0 mm to about 150 mm. In a further refinement, fibrous pads fibrous pads 20, 28, 36, 46, 58, 60, 76 and fibrous cushion sections 22, 30, 38, 48, 66, 80 set forth above have a caliper thickness of from about 1.0 mm to about 20 mm. In still a further refinement, fibrous pads 20, 28, 36, 46, 58, 60, 76 and/or fibrous cushion sections 22, 30, 38, 48, 66, 80 set forth above have a caliper thickness of from about 1.0 mm to about 3 mm.

In a variation of the present embodiment, the cellulosic and natural fibers are characterized by a denier from about 1.0 dpf to about 4.0. In another variation, the cellulosic and natural fibers are characterized by a denier from about 1.5 dpf to about 2.5 dpf. In still another refinement, the cellulosic and natural fibers each independently have a length from about 3 mm to about 12 mm. In yet another refinement, the cellulosic and natural fibers each independently have a length from about 4.5 mm to about 7.5 mm.

In a variation of the present embodiment, the fibrous sections set forth above have a density from about 30 kg/m³ to about 50 kg/m³. In a further refinement, the fibrous sections set forth above have a density from about 35 kg/m³ to about 75 kg/m³. In still a further refinement, the fibrous sections set forth above have a density from about 37 kg/m³ to about 43 kg/m³.

In a variation of the present embodiment, the fiber section set forth above includes a binder. Examples of suitable binders include, but are not limited to, bicomponent fiber binders, latex binders, thermoplastic materials, and combinations thereof. In a refinement, the binder is present in amounts ranging from about 5 weight percent to about 70 weight percent of the total weight of the fiber section . In another refinement, the binder is present in amounts ranging from about 20 weight percent to about 40 weight percent of the total weight of the fiber section.

In another variation of the present embodiment, the fiber section further comprises a fire retardant. Examples of suitable fire retardants include, but are not limited to, sodium borate, sodium or ammonium phosphates, phosphate esters, diammonium phosphate based flame retardants, sodium tetraborate decahydrate, and combinations thereof.

While embodiments of the invention have been illustrated and described, it is not intended that these embodiments illustrate and describe all possible forms of the invention. Rather, the words used in the specification are words fo description rather than limitation, and it is understood that various changes may be made without departing from the spirit and scope of the invention.

What is claimed:

1. A deformable structure comprising:
a substrate;
a fibrous cushion element disposed over the substrate, the fibrous cushion element comprising cellulosic fibers and less than 50 weight percent of a resinous foam; and
a cover disposed over the cushion element.

2. The deformable structure of claim 1 wherein the fibrous cushion element further comprises synthetic fibers.

3. The deformable structure of claim 2 wherein the synthetic fibers comprise a component selected from the group consisting of polyester fibers, nylon fibers, latex fibers, polyethylene fibers, polypropylene fibers, and combinations thereof.

4. The deformable structure of claim 2 wherein the synthetic fibers are present in a combined amount ranging from about 15 weight percent to about 95 weight percent based on the total weight of the fiber section .

5. The deformable structure of claim 1 wherein the fibrous cushion element further comprises a binder.

6. The deformable structure of claim 5 wherein the binder is present in an amount from about 5 weight percent to about 70 weight percent of the total weight of the fiber section.

7. The deformable structure of claim 5 wherein the binder comprises a component selected from the group consisting of bicomponent fiber binders, latex binders, thermoplastic materials, and combinations thereof

8. The deformable structure of claim 4 wherein the fibrous cushion element includes a fibrous cushion section.

9. The deformable structure of claim 8 wherein the fibrous cushion element includes a fibrous pad that covers a surface of the fibrous cushion section.

10. The deformable structure of claim 8 wherein the cushion element is adapted to be placed in a seat.

11. The deformable structure of claim 1 wherein the cover comprises a component selected from the group consisting of a non-woven fabric, a woven fabric, leather, a plastic sheet and combinations thereof.

12. A trim laminate comprising the deformable structure of claim 1.

13. A cushion element for automotive interior components, the cushion element comprising:
a fiber pad comprising cellulosic fibers; and
a fibrous cushion section contacting the fiber pad.

14. The cushion element of claim 13 wherein the fiber pad further comprises synthetic fibers.

15. The cushion element of claim 13 wherein the fibrous cushion section further comprises synthetic fibers.

16. The cushion element of claim 15 wherein the synthetic fibers comprise a component selected from the group consisting of polyester fibers, nylon fibers, latex fibers, polyethylene fibers, polypropylene fibers, and combinations thereof.

17. The cushion element of claim 16 wherein the synthetic fibers are present in a combined amount ranging from about 15 weight percent to about 95 weight percent based on the total weight of the fiber section.

18. The cushion element of claim 14 wherein the fiber pad and the fibrous cushion section each independently further comprise a binder.

19. The cushion element of claim 18 wherein the binder comprises a component selected from the group consisting of bicomponent fiber binders, latex binders, thermoplastic materials, and combinations thereof.

20. A deformable structure comprising:
a cushion element including:
a fibrous cushion section;
a fibrous pad disposed over a portion of the fibrous cushion section, the fibrous pad comprising cellulosic fibers; and
a cover disposed over the cushion element.
